(19) United States
(12) Patent Application Publication
(10) Pub. No.: US 2007/0076528 A1
(43) Pub. Date: Apr. 5, 2007

(54) Improved Wireless Timing System

(76) Inventor: Richard Albert Kirby, St. Martin d'Uriage (FR)

Correspondence Address: Richard Kirby, Suite A, 2300 SW 2nd Street, McMinnville, OR, 97128, US

(21) Appl. No.: 11/163,048

(22) Filed: Oct. 3, 2005

(51) Int. Cl. G04C 11/02

(52) U.S. Cl. 368/47

(57) ABSTRACT

An improved wireless timing system shown in FIG. 1 comprising a means of transmitting wirelessly a signal (12) triggered by the reception of an electrical impulse from a timing event detector (11). The transmitter (12) being low power and thus short range to reduce cost, power consumption and interference with other timing systems. The individual or object being timed transports a portable timing unit (16), which could be in the form of a wrist watch, that is capable of receiving the wireless timing signal and calculating the passage of time between successive receptions of timing signals.

### CROSS-REFERENCE TO RELATED APPLICATIONS

Not applicable.

### FEDERALLY SPONSORED RESEARCH

Not applicable.

### SEQUENCE LISTING OR PROGRAM

Not applicable.

### BACKGROUND OF THE INVENTION

1. Field of Invention

This invention relates to sports equipment, specifically to an improved wireless timing system for timing individual athletic events.

2. Prior Art

In many sporting events (e.g. running, skiing, cycling, equestrian, car racing, etc.) where there is a competition against the clock, precise timing is required to determine the results of a competition or to improve performance in training sessions. Today's timing systems typically consist of a central timing unit linked to one or more signaling devices that can be precisely triggered when certain events, such as the passage of an athlete, occur. The signaling devices could be one or more photocells, a start gate wand for skiing, or the sound of a starting pistol for some track and field events.

When the start and the finish of an event are in different locations, as is common in running, skiing, cycling, and rally car racing, a means of transmission between the signaling device and the central timing unit is required. This is typically a cable or a wireless transmission. When the start and finish are a reasonable distance apart (more than a few hundred meters) running a cable becomes difficult and a wireless system is nearly always used to link the start and finish areas except for very high level competitions.

The wireless timing systems available today have a number of disadvantages. Because the start and finish of athletic events can be several kilometers apart, the transmitter must be powerful enough to reliably transmit over this distance across terrain which may contain obstacles to wireless transmissions. To increase the reliability of the timing signal, the transmitters used in wireless timing systems of today transmit the data slowly (2400 to 9600 baud) sending multiple data packets over relatively long periods of time (1 to 3 seconds). This causes a saturation at certain frequencies that can prevent all timing systems in the area from functioning properly. This is a significant problem when training for ski racing when there may be 30 timing systems functioning simultaneously within a few hundred meters of each other. This problem is serious enough that many teams train without a timing system because of the lack of reliability caused by saturated frequencies used by wireless timing systems.

Transmission reliability is also affected by the terrain, with transmissions being blocked by undulating terrain or large buildings.

The wireless timing systems of today are expensive because specialty high power transmitters are required and they use relatively large amounts of power for battery operated devices.

In addition to the issues with the reliability of the signal and the cost of high power transmitters, the fact that there is one central timing unit creates additional problems. Since multiple athletes usually pass through the signaling devices, a person must code into the central timing unit an identifier for each athlete and each start time. This usually requires a dedicated person at the start of the event. Since all times and splits are captured in the central timing unit, the athlete only has immediate access to his/her final time if there is a large timing board at the finish (which is very expensive and is almost never used for training) and split times are rarely available until downloaded or printed out from the central timing unit which is usually hours after the training session or event is over and the athlete has already left the venue.

On many occasions, timepieces that include RF reception capabilities have been proposed. Teodoridis, in U.S. Pat. No. 4,884,252 (1989), Hama in U.S. Pat. No. 5,532,705 (1996), and Kita and Suga in U.S. Pat. No. 6,825,751 (2004) are several examples. In addition, many portable devices such as pagers, portable phones, and portable GPS systems include built-in time keeping capability and the ability to receive and synchronize with an externally generated and transmitted timing signals. None of these devices, however, incorporate the ability to determine elapsed time based two or more externally triggered events. Thus they are not capable of performing the function of a wireless timing system.

On Oct. 26, 2004 a group of engineering students at the University of Massachusetts working under professor Andreas Muschinski proposed a timing system for skiers that consisted of a portable timer worn by the skier that was triggered by photocells fixed on a ski course. This proposal, however, cannot be considered prior art because this inventor (Richard Kirby) can demonstrate through lab book entries a conception date of Aug. 27, 2003 and a reduction to practice on Oct. 20, 2003. Even more concretely, on Oct. 1, 2003 a preliminary specification for prototypes of this invention were delivered to a customer and on Mar. 5, 2004 this customer purchased two of these prototype systems. The information about the invention received by the customer was protected from public disclosure via a confidential disclosure agreement.

In summary, all known existing wireless sports timing systems suffer from the following disadvantages:
(1) The transmission is inherently unreliable due to interference from other systems and obstacles between the transmitter and receiver.
(2) Transmitters are expensive due to the high powered transmitter components required to transmit over longer distances.
(3) Power consumption is relatively high for a battery powered device requiring larger more expensive batteries and more frequent battery replacement.
(4) A dedicated person is required to code into a central unit an identification of each athlete and for each start time.
(5) Timing information is generally not available until long after the event with the exception of the final time which is only available via expensive outdoor displays. Splits are rarely available until long after the training session or event.

### BACKGROUND OF THE INVENTION—OBJECTS AND ADVANTAGES

Accordingly, several objects and advantages of the present invention are:
(1) To provide a highly reliable wireless timing system which is inherently immune to external radio frequency noise and minimizes the radio frequency noise it generates that could affect other systems.
(2) To provide a substantially lower cost solution to traditional wireless timing systems.
(3) To provide a low power solution for long battery life.
(4) To provide an autonomous system that does not require entering athlete identification into a central unit.
(5) To provide a system where athletes can have immediate access to all their individual data including finishing times and splits.

Still further objects and advantages will become apparent from a study of the following description and the accompanying drawings.

### SUMMARY

In accordance with the present invention a wireless timing system comprising a short range (less than 200 meters) means of transmitting wirelessly a signal that precisely indicates when an external timing event occurs which is received by a portable timing device that can be transported by an individual or object being timed.

In the drawings, closely related figures have the same number but different alphabetic suffixes.

### DRAWINGS—FIGURES

FIG. 1 Overview of improved wireless timing system.

FIG. 2 Block diagram of portable timing unit.

FIG. 3 Block diagram of transmitter

FIG. 4 Block diagram of central unit

FIG. 5 Contents of wireless data packet sent by transmitter

FIG. 6 Contents of wireless beacon packet sent by central unit

FIG. 7 Contents of wireless data packet sent by portable timing unit to central unit

FIG. 8 Software flowchart for portable timing unit

FIG. 9 Software flowchart for transmitter

FIG. 10 Software flowchart for central unit

### DRAWING—REFERENCE NUMBERS

11 Timing event detector
12 Transmitter
14 Portable timing unit
16 Athlete or object being timed
18 Central unit
20 Cable
22 Data packet of timing information (transmitter to portable timing unit packet)
24 8-bit preamble (transmitter to portable timing unit packet)
26 16-bit global address (transmitter to portable timing unit packet)
28 16-bit timing delay information (transmitter to portable timing unit packet)
30 8-bit packet type descriptor (transmitter to portable timing unit packet)
32 16-bit CRC checksum (transmitter to portable timing unit packet)
34 Beacon data packet sent by central timing unit
36 8-bit preamble (beacon packet)
38 16-bit global address (beacon packet)
40 8-bit beacon descriptor (beacon packet)
42 16-bit CRC checksum (beacon packet)
44 Data packet sent by portable timing unit to central unit
46 8-bit preamble (portable timing unit to central unit packet)
48 16-bit global address (portable timing unit to central unit packet)
50 16-bit timing information (portable timing unit to central unit packet)
51 16-bit unique portable timing unit identifier
52 8-bit packet type descriptor (portable timing unit to central unit packet)
54 16-bit CRC checksum (portable timing unit to central unit packet)
56 Microprocessor (portable timing unit)
58 Means of providing an accurate timing signal—clock (portable timing unit)
60 Means of transmitting a wireless signal—receiver (portable timing unit)
62 Means of receiving a wireless signal—transmitter (portable timing unit)
64 Means of accepting user input—input device (portable timing unit)
66 Means of providing user feedback
68 Power supply (portable timing unit)
70 Memory (portable timing unit)
71 Microprocessor (transmitter)
72 Means of receiving a timing impulse from an external source
73 Timing signal source
74 Means of providing an accurate timing signal (transmitter)
76 Means of transmitting a wireless signal (transmitter)
78 Means of accepting user input (transmitter)
80 Power supply (transmitter)
81 Microprocessor (central unit)
82 Means of receiving a wireless signal (central unit)
84 Means of transmitting a wireless signal (central unit)
86 Means of accepting user input (central unit)
88 Means of communicating with the user
90 Power supply (transmitter)
92 Memory

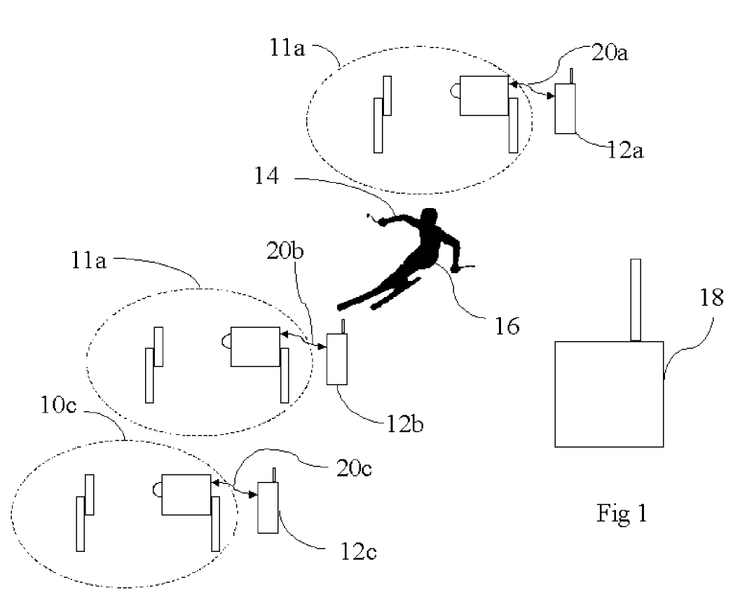

### DETAILED DESCRIPTION—FIG. 1 OVERVIEW

An overview of a preferred embodiment of the present invention is illustrated in FIG. 1—Overview of improved wireless timing system. One or more timing event detectors 11a to 11c are attached to transmitters 12a to 12c by cables 20a to 20c. Any common timing event detector such as a photocell, a starting gate wand for skiing, a starting pistol for certain track and field events, or any other system that provides an electrical impulse that is associated with a timing event can be used. In the preferred embodiment the cable is a common two conductor insulated cable but any means of transmitting the electrical impulse could be used.

An athlete or object being timed 16, transports or wears a portable timing unit 14. A central unit 18 is located somewhere in the area of the event, preferably near the finish of the event. Each of these three components of the system: the transmitter 12, the portable timing unit 14, and the central unit 18 will now be described in greater detail.

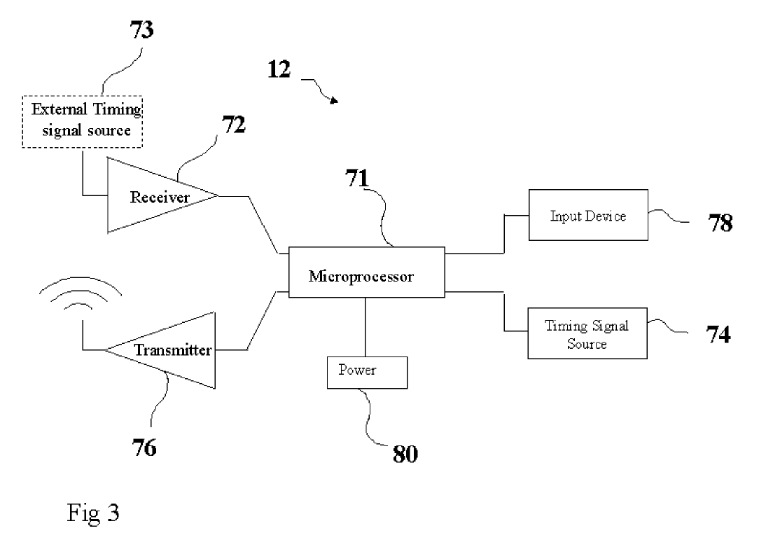

### DETAILED DESCRIPTION—FIG. 3 AND FIG. 6 TRANSMITTER

FIG. 3 shows a block diagram of the transmitter 12 that comprises a microprocessor 71, a means of receiving a timing impulse from an external source 72 connected to an external timing signal source 73 (starting wand, photo cell, starting pistol, etc.), a means of providing an accurate timing signal 74, a means of transmitting a wireless signal 76, a means of accepting user input 78, and a power supply 80.

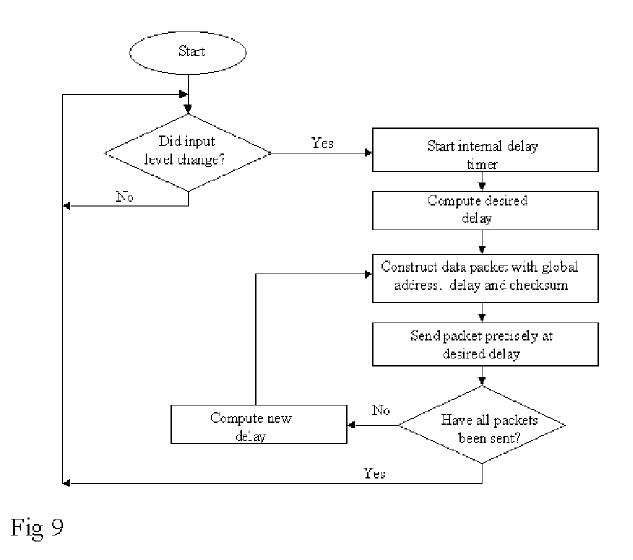

In the preferred embodiment a Microchip PIC18F4550 is used for the microprocessor 71. It executes the firmware shown in FIG. 9 and described in the operation section of this document. One of the input gates of the microprocessor 71 is connected to the means of receiving the timing impulse 72 which in the preferred embodiment is a buffered gate with a weak pull-up. One skilled in the art could conceive of numerous ways of detecting an external electrical impulse with a microprocessor.

In the preferred embodiment, the means of providing an accurate timing signal 74 is via a commonly available temperature stabilized quartz oscillator circuit. The timing signal 74, however, need not be generated internal to the transmitter 12. It could come, for example, from an external source such as the Global Positioning System (GPS) signal.

In the preferred embodiment the means of transmitting a wireless signal or transmitter component 76 is a low cost 2.4 GHz GFSK transceiver like the Nordic Semiconductor nRF2401 that is capable of transmitting up to 1 Mbit of information a second. However, any kind of short range (less than 200 meter) wireless transmission system can be used. The transmitter component is in communication via a 3-wire serial interface with the microprocessor 71.

The means of accepting user input 78 consists of push buttons which are connected to other input ports on the microprocessor 71. One skilled in the art could conceive of many different types of input included a common DIP switch for configuring certain parameters. The power supply 80 is a common battery.

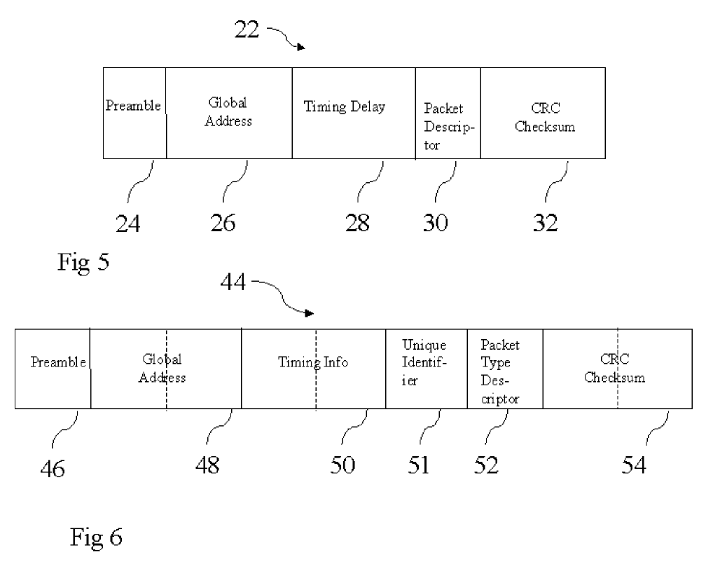

FIG. 5 shows the contents of a data packet of timing information 22 sent by the transmitter 12 to the portable timing unit 14. In the preferred embodiment, the data packet of timing information 22 contains an 8-bit preamble 24, a 16-bit global address 26, a 16-bit timing delay information 28, an 8-bit packet type descriptor 30, and a 16-bit checksum value 32. All data packet types include a preamble identical to the 8-bit preamble 24 that allows the receiver to “lock” onto the transmission. In addition, all packet types include a global address like the 16-bit global address 26 which allows multiple system functioning in the same vicinity to identify communications destined for “their” system. Certainly other length addresses and preambles could be used.

The 16-bit timing delay information 28 defines the delay between the point in time that the transmitter received the electrical timing impulse from the timing event detector 11 via the cable 20 and the subsequent completion of the transmission of the wireless packet 22. This delay includes the hardware delay associated with the reception of the electrical signal, the software delays associated with the functioning of the transmitter, and the delay associated with the transmission of the data packet of timing information 22 itself. One skilled in the art will know how to write the transmitter firmware such that all decision paths have equivalent execution times so that the delay is perfectly predictable. Like the other elements of the data packet, the length of the timing delay information 28 could be a broad range of lengths.

The packet type descriptor 30 defines the type of transmission (e.g. start, split, stop, speed trap, etc.). Like the preamble 24 and global address 26 all wireless packets include a CRC checksum like the 16-bit CRC checksum 32, that permit a verification that the packet was transferred without data corruption. A CRC checksum is common knowledge to one skilled in the art. In addition, one skilled in the art could conceive of numerous different ways of constructing a data packet to transmit timing information and containing an address and means of verifying that the packet was received without corruption.

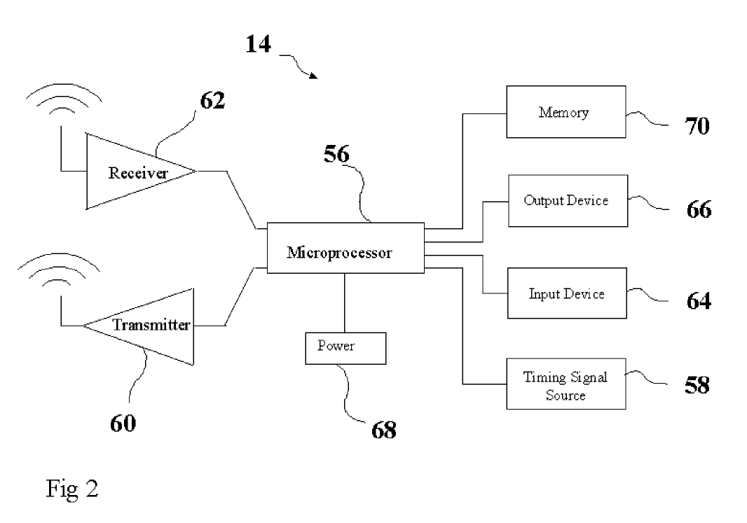

### DETAILED DESCRIPTION—FIG. 2 PORTABLE TIMING UNIT

FIG. 2 shows a block diagram of the portable timing unit 14 which is carried by the athlete 16. It consists of a microprocessor 56, which contains or is attached to a means of providing an accurate timing signal—clock 58, the receiver 60, a means of transmitting a wireless signal—transmitter 62, a means of accepting user input—input device 64, a means of providing user feedback 66, a power supply 68, and a memory 70.

In the preferred embodiment, the microprocessor 56 is a Microchip PIC 18F2525 and it executes the firmware displayed in the flowchart in FIG. 8 and described in the next section. In the preferred embodiment, the clock 58, is a commonly available temperature stabilized quartz oscillator circuit. The clock 58, however, need not be internal to the portable timing unit 16. It could come, for example, from an external source such as the Global Positioning System (GPS) signal or could be received as part of the data packet of timing information 22 sent by the transmitter 12.

In the preferred embodiment the means of transmitting a wireless signal 62 and the means of receiving a wireless signal 60 are the same as for the transmitter 12, the nRF2401 from Nordic Semiconductor. One skilled in the art could conceive of numerous other ways of receiving and transmitting a wireless signal. As with the transmitter 12, the transmitter component 62 and receiver component 60 are in communication via a 3-wire serial interface with the microprocessor 56.

In the preferred embodiment, the means of accepting user input 64 consist of push buttons which are connected to other input ports on the microprocessor 71. One skilled in the art could conceive of many different types of input devices included a voice activated system. In the preferred embodiment the means of providing user feedback 66 is an LCD display and the memory 70 is a non-volatile flash type memory both in communication with the processor via a 3-wire serial interface. The means of providing user feedback 66 could also be audible or via a head-up display type system. The power supply 68 is a common battery.

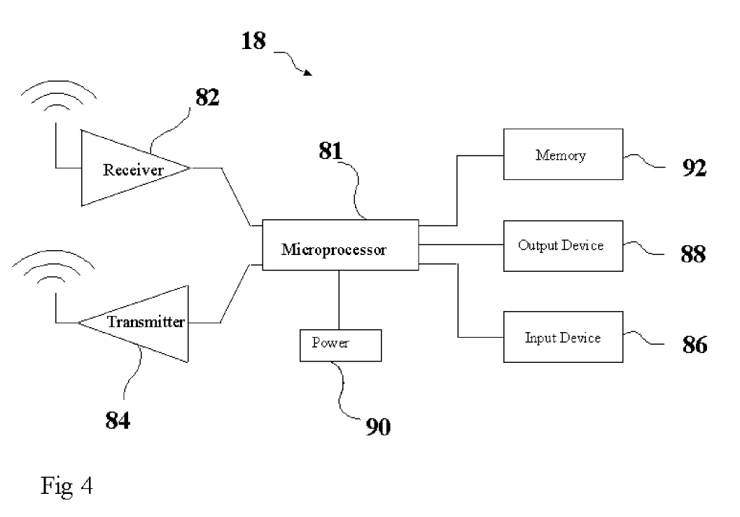

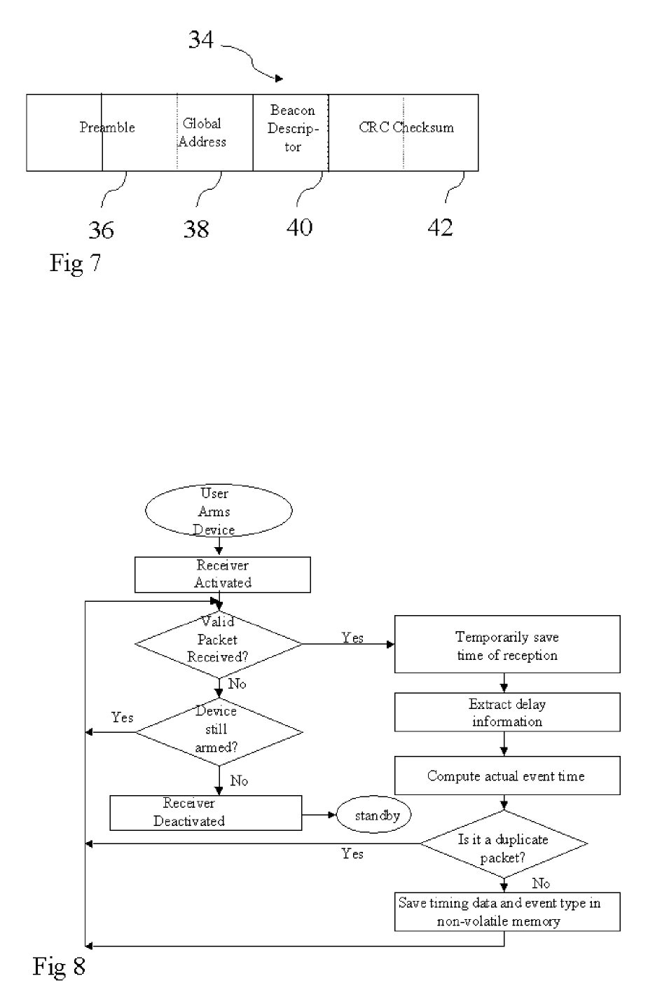

### DETAILED DESCRIPTION—FIG. 4, FIG. 6 AND, FIG. 7 CENTRAL UNIT

FIG. 4 shows a block diagram of the central unit 18 comprising a microprocessor 81 a means of receiving a wireless signal 82, a means of sending a wireless signal 84, a means of accepting user input 86, a means of communicating with the user 88, a power supply 90 and memory 92.

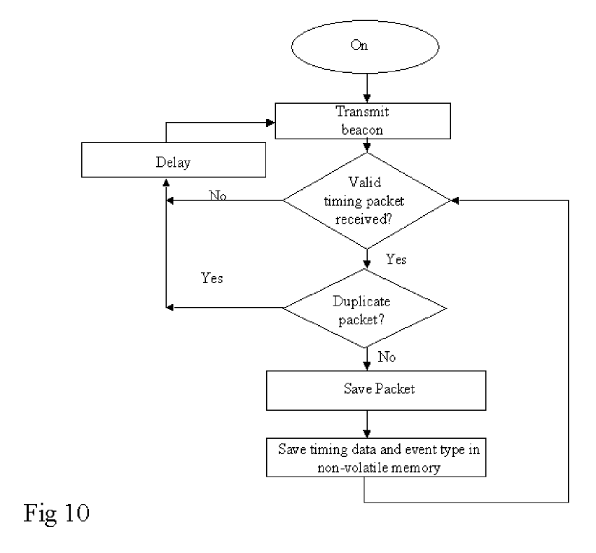

In the preferred embodiment a Microchip PIC18F4550 is used for the microprocessor 81. It executes the firmware shown in FIG. 10 and described in the operation section of this document.

In the preferred embodiment the means of sending a wireless signal 84 and the means of receiving a wireless signal 82 are the same as for the transmitter 12, the nRF2401 from Nordic Semiconductor. One skilled in the art could conceive of numerous other ways of receiving and transmitting a wireless signal. As with the transmitter 12, the transmitter component 84 and receiver component 82 are in communication via a 3-wire serial interface with the microprocessor 81.

The means of accepting user input 86 consists of a matrix keypad connected in a common row and column format of input and output gates of the microprocessor 81 and scanned as is commonly done for reading the input from a matrix keypad. One skilled in the art could conceive of many different types of input included a voice activated system. In the preferred embodiment the means of communicating with the user 88 is a LCD display and the memory 92 is a non-volatile flash type memory both in communication with the microprocessor 81 via a 3-wire serial interface. The power supply 90 is a common battery.

The central unit initiates wireless communication by broadcasting a beacon data packet 34 shown in FIG. 7. In the preferred embodiment the beacon data package 34 consists of an 8-bit preamble 36, a 16-bit global address 38, an 8-bit beacon descriptor 40, and a 16-bit CRC checksum 42. The 8-bit preamble 36, 16-bit global address 38, and 16-bit CRC checksum 42 serve the same purpose as in the previously described data packet of timing information 22. The 8-bit beacon descriptor 40 defines the data packet as a beacon package. Although this is the preferred embodiment, this data packet could be constructed in numerous different ways.

When a portable timing unit 14 receives a beacon data packet 34 and has timing information that has not yet been transferred to a central unit the portable timing unit 14 responds to the beacon data packet 34 by sending a timing record data packet 44 for each record of timing data. This data packet contains an 8-bit preamble 46 a 16-bit global address 48, a 16-bit timing information 50, a 16-bit unique portable timing unit identifier 51, an 8-bit packet type descriptor 52, and a 16-bit CRC checksum 54. The preamble 46, global address 48, packet type descriptor 52, and CRC checksum 54 perform the same functions as in other packet types. The timing information 50 consists of the elapsed time of a particular timing record from the most recent data record with a start descriptor in the packet type descriptor 52. One skilled in the art could envisage numerous different ways of coding timing data into wireless packets.

### OPERATION—FIG. 8 PORTABLE TIMING UNIT

FIG. 8 shows a flow chart for the software in the portable timing unit 14. In its default state, the portable timing unit 14 is unarmed. In this state the receiver 60 is off and the portable timing unit 14 may perform other functions such as those of a standard wristwatch. It may also allow the user to review previously recorded times and splits. Many such sports watches exist today and one skilled in the art will have no difficulty constructing a portable timing unit with these functions. In the unarmed state, the portable timing unit 14 will not respond to a data packet of timing information 22 and thus can be in the vicinity of a transmitter 12 while other athletes are being timed without being affected.

The flowchart in FIG. 8-Software flowchart for portable timing unit, starts when the portable timing unit 14 is armed. Arming the portable timing unit 14 could be done manually by the user via the input device 64, or could be automatic. In an automatic scenario, the portable timing unit 14 may “wake-up” the receiver 60 at a regular intervals to check for a “wake-up” command or a simple reed switch that is triggered by a magnet when the athlete enters the start area. The details of how to “wake-up” and arm a sleeping device are well know to one skilled in the art and are not described here. Typically the portable timing unit is armed moments before the start of the event to be timed to prevent the passage of one athlete through the timing event detector 11 from triggering another athletes portable timing unit 14.

Once the receiver 60 has been activated, it continuously monitors wireless transmissions. The receiver component 62 of FIG. 2 locks onto a string of bits when it receives a valid preamble 24 of FIG. 5. The next 56 bits are received, the 16-bit global address 26 in the packet is compared to the previously configured 16-bit global address in the portable timing unit 14 and a checksum is calculated and verified against the 16-bit CRC checksum 32 received in the wireless data packet 22. If the global address stored in the portable timing unit 14 and the calculated CRC checksum matches the 16-bit CRC checksum 32 the packet is considered a valid data packet of timing information 22 and the receiver 60 interrupts the microprocessor 56. This sequence of events is performed within nRF2401 receiver component from Nordic Semiconductor and a detailed explanation of how this operates is available in the Nordic Semiconductor data sheet for this component.

In the preferred embodiment, immediately upon receiving the interrupt from the receiver, the microprocessor captures the time from the timing signal source 58 in FIG. 2. This time is stored by the microprocessor 56 in a temporary memory location within a volatile microprocessor memory register. The microprocessor 56 then extracts the 16-bit timing delay information 28 from the wireless data packet 22 and subtracts this delay from the time the packet was received to get the time that the timing signal was received by the transmitter 12. The microprocessor 56 then verifies if this is a new data packet or a data packet that had already been received by comparing the calculated event times. If it is a new packet, the microprocessor 56 saves the time and the type of packet (start, stop, split, etc.) in non-volatile memory 70.

A multitude of additional functions could be added. For example a “speed-trap” capability could be added so that anytime two distinct data packets of timing information 22 coded as speed-trap packets are received sequentially, the portable timing unit 14 calculates the speed based on the time and the distance between the two “speed-trap” timing events. The distance between two speed-trap events could be transmitted as part of the 8-bit packet type descriptor 52. For example, a speed trap event may be coded as bit 7 of the 8-bit packet type descriptor being high (all other packet types would have bit 7 low). If bit 7 is high, than bits 0 through 6 define the distance between the timing event detectors for the two speed-trap events.

A typical data packet of timing information 22 coded as a speed trap packet could look like this: 1000 1010 in binary form. The first 1, bit 7 is high. This signifies that this data packet of timing information 22 is a speed trap type packet. The remaining 7 bits 000 1010 in binary equal 10 in decimal and signify that this speed trap packet came from a speed trap where the two timing event detectors (11b and 11c for example) were set 10 meters apart. The speed would then be calculated as 10 meters divided by the elapsed time between the two speed trap data packets to arrive at the speed in meters per second. The speed in kilometers per hour or miles per hour can then be computed by applying the correct conversion factor.

### OPERATION—FIG. 9 TRANSMITTER

FIG. 9 shows a flow chart for the software in the transmitter 12. When the transmitter 12 detects a level change via the means of detecting a level change 72 from the external timing source 73 the microprocessor 71 starts an internal delay timer using the means of providing an accurate timing signal 74. In addition to the normal delay caused by the software execution in the microprocessor 71, a random delay is added to ensure that two transmitters 14 in the same vicinity don't align their sequence of data packet 22 transmissions. The data packet 22 is then transmitted precisely when it should be according to the desired delay, this delay being transmitted with the packet as the 16-bit delay timing delay information 28. The above process is repeated multiple times to ensure a valid transmission. In the preferred embodiment, the transmissions occur every millisecond for 1/10^{th} of a second or 100 transmissions.

An acknowledgement feature could be added to both the portable timing unit 14 and the transmitter 12 such that the transmitter sends a single data packet of timing information 22 and then waits a period of time to receive an acknowledgement. If it receives the acknowledgement it does not retransmit data packet 22. One skilled in the art will be able to easily implement an acknowledgement feature and such a feature will not be described here.

The data packets of timing information 22 could be encrypted with strong encryption that would prevent falsification or interception of timing information. One skilled in the art would be able to code and decode the data packets of timing information 22 in encrypted form.

### OPERATION—FIG. 10 CENTRAL UNIT

FIG. 10 shows a flow chart for the software in the central unit 18. The central unit 18 sends out a regular beacon packet 34 and then listens for a response. In the preferred embodiment, the beacon packet 34 is sent out once a second and is shown in FIG. 6. The beacon packet includes an 8-bit preamble 36, 16-bit address 38, and 8-bit beacon descriptor 40, and a 16-bit CRC checksum 42. When a portable timing unit 14 is in the vicinity of the central unit and is armed it can receive the beacon packet 34. When a valid beacon packet 34 is received the portable timing unit 14 transmits all stored timing data that has not already been transferred once before. Each packet of timing data packet 44 is sent individually and the portable timing unit 14 waits for an acknowledgement from the central unit that it received correctly each timing data packet 44. The timing data packet 44 transferred from the portable timing unit 14 to the central unit 18 is shown in FIG. 6. It contains an 8-bit preamble 46, a 16-bit global address 48 which defines the ensemble of transmitters, portable timing units, and a central unit, a 16-bit timing information 50, a 16-bit unique portable timing unit identifier 51 that uniquely identify which portable timing unit the data is coming from, and a 16-bit CRC checksum 54.

### ADDITIONAL EMBODIMENTS

In one alternative embodiment, the transmitters can use a common timing source (e.g. timing information from the GPS signal) and instead of transmitting timing delay information, the transmitters transmit the absolute time of the timing event. In this embodiment, the means of providing an accurate timing signal 74 is the GPS satellite (or other large area wireless timing system that contains accurate absolute time information) which is external to the portable timing unit.

In a second alternative embodiment, the portable timing unit can be incorporated in a helmet, a pair of goggles with a built in heads-up display where timing information is displayed to the athlete during the event, or other sporting equipment (e.g. as part of the ski or ski binging, on the dashboard of the car, etc.). In the case of a pair of goggles with a heads-up display, an athlete such as a skier could see his intermediate times relative to the best intermediate time of the day or the speed as he/she completed a speed trap passage.

### ADVANTAGES

From the description above a number of advantages of the improved wireless timing system become evident:
(1) The reliability of transmission with existing wireless timing systems are related to the relatively long distances between the start and finish (often measured in kilometers) which forces the use of slow transmission (2400 to 9600 baud), and lengthy transmission times (measured in 100ths of a second). The improved wireless timing system presented here has substantially higher reliability because of the very short range transmission (several meters vs. several kilometers) and the very short transmission time (measured in uS) which significantly reduces the chance of data corruption due to other signals at the same frequency.
(2) The preferred embodiment uses a low power high volume transceiver often used in common wireless network applications. Because of the higher manufacturing volumes and substantially lower power required the transceiver portion of the circuit has a 10:1 manufacturing cost advantage over traditional transmitter components used in today's wireless timing systems.
(3) A typical 2.4 GHz transceiver designed for 10 meter transmission distances uses about 20 mA of power for bursts of 64 uS transmissions. The average power consumption at a 6.4% duty cycle is 1.28 mAs. A traditional system using a 10 mW transmitter running at 9600 baud uses 40 mA with a nearly continuous duty cycle or 30 times the power consumption.
(4) Since each portable timing unit has a unique identifier, there is no need to enter bib numbers or athletes names into a central unit. The timing data is tied automatically to the unique identifier in the portable timing unit and this data is uploaded back to the central unit automatically.
(5) Because the portable timing unit stays with the athlete, the athlete has immediate access to all his/her times including splits for the current event, and for all past events. This provides a substantial improvement in athlete training.

### CONCLUSION, RAMIFICATIONS, AND SCOPE

Accordingly, the reader will see that the improved wireless timing system of this invention is more reliable, lower power, and lower cost then wireless timing systems available today. In addition the improved wireless timing system of this invention provides individual athletes all their timing information instantaneously and eliminates the need for a person dedicated to managing a central timing unit.

Although the description above contains many specificities, these should not be construed as limiting the scope of the invention but as merely providing illustrations of some of the presently preferred embodiments of this invention. For example the portable timing unit may be capable of keeping time itself or it may receive the timing signal from and external source. The portable timing unit may be in the form of a watch worn by the athlete or it may be incorporated into a piece of sporting equipment. Any type of short range wireless transmission is acceptable. There are numerous different ways to transfer the timing data in wireless data packages. It is also possible to use the improved wireless timing systems in places where timing systems aren't typically used today, e.g. for doing time and motion studies or for monitoring the behavior of individuals for consumer behavior studies.

What is claimed is:

1. A wireless timing system comprising:
a means of transmitting wirelessly a signal that precisely indicates when an external timing event occurs
said means of transmitting wirelessly a signal not having sufficient range to entirely cover the event being timed
a portable means of determining elapsed time transported by the individual or object being timed
a means of controlling said portable means of determining elapsed time by said signal
whereby an external event that starts in one location and finishes in another location can be timed without the need of a direct communication link between the starting event location and the finishing event location.

2. The wireless timing system in claim one wherein said portable means of determining elapsed time is in the form of a wrist watch.

3. The wireless timing system in claim one further including a means of detecting duplicate timing signals.

4. The wireless timing system in claim one further including a means calculating speed.

5. The wireless timing system in claim one further including a means of encrypting the wireless timing signal.

6. The wireless timing system in claim one further including a means of coding an address in the timing signal.

7. The wireless timing system in claim one further including a means of detecting if said timing signal is corrupted.

8. A wireless timing system comprising:
a means of transmitting wirelessly a signal that precisely indicates when an external timing event occurs
said means of transmitting wirelessly a signal not having sufficient range to entirely cover the event being timed
a portable means of determining elapsed time transported by the individual or object being timed
a means of controlling said portable means of determining elapsed time by said signal
and a means of correcting said timing signal to reflect the true time of the event based on delay information passed by said timing signal
whereby an external event that starts in one location and finishes in another location can be timed without the need of a direct communication link between the starting event location and the finishing event location.

9. The wireless timing system in claim 8 wherein said portable means of determining elapsed time is in the form of a wrist watch.

10. The wireless timing system in claim 8 further including a means of detecting duplicate timing signals.

11. The wireless timing system in claim 8 further including a means of encrypting the wireless timing signal.

12. The wireless timing system in claim 8 further including a means of coding an address in the timing signal.

13. The wireless timing system in claim 8 further including a means calculating speed.

14. The wireless timing system in claim 8 further including a means of detecting if said timing signal is corrupted.

15. A method for timing an event that starts in one location and finishes in another location comprising the steps of:
providing a means of transmitting wirelessly a signal that precisely indicates when an external timing event occurs
said wireless signal not having sufficient range to entirely cover the event being timed
providing a portable means of determining elapsed time transported by the individual or object being timed
providing a means of controlling said portable means of determining elapsed time by said signal
whereby an external event that starts in one location and finishes in another location can be timed without the need of a direct communication link between the starting event location and the finishing event location.

16. The method of claim 15 wherein said portable means of determining elapsed time is in the form of a wrist watch.

17. The method of claim 15 further including a means of detecting duplicate timing signals.

18. The method of claim 15 further including a means of encrypting the wireless timing signal.

19. The method of claim 15 further including a means of coding an address in the timing signal.

20. The method of claim 15 further including a means calculating speed.
